(19) United States
(12) Patent Application Publication
(10) Pub. No.: US 2009/0315906 A1
(43) Pub. Date: Dec. 24, 2009

(54) CACHE ARRANGEMENT FOR GRAPHICAL APPLICATIONS

(75) Inventor: Nigel Keam, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/141,252

(22) Filed: Jun. 18, 2008

(51) Int. Cl. G09G 5/36

(52) U.S. Cl. 345/557

(57) ABSTRACT

A cache arrangement for graphical applications is disclosed. One embodiment comprises receiving a first address having a first n-bit portion and corresponding to a first pixel, receiving a second address having a second n-bit portion and corresponding to the first pixel, reversing the order of the second n-bit portion to form a reversed n-bit portion, and generating a first cache entry number derived from the first n-bit portion and the reversed n-bit portion.

### BACKGROUND

A data cache reduces average memory access times by storing local copies of data, for example local copies of frequently used data from a main memory. A data cache has a cache entry number, or index, that is associated with a tag. In some embodiments a tag may be an address, or an index, from a location in main memory. When a cache stores a local copy of data from main memory, the data will be associated with the cache entry number and the address from main memory. In this way, when a request for a main memory address or data from a main memory is received, the cache can be scanned for a corresponding tag and the data can then be accessed locally, with less latency. Unfortunately, data caches have a limited amount of memory space and therefore do not store a local copy of all data from main memory.

Some applications create data cache management problems. For example, in a direct mapped cache, main memory locations are directly mapped to cache locations, causing cache over-writes and therefore countering the reduced latency offered by caching locally stored data. This can be problematic when a direct-mapped cache is used to store data related to graphical applications, or multiple dimensional arrays of data, such as a pixel array, a texel array, etc. When an application attempts to retrieve data from adjacent addresses within the array, the cache organization scheme may re-write a cache entry multiple times, increasing latency for data retrieval.

A set-associative caching scheme may be used to decrease the amount of over-writes for similar cache entry numbers, unfortunately current set-associative caching schemes generate a corresponding increase in management overhead.

### SUMMARY

Accordingly, various embodiments for a cache arrangement for graphical applications are described below in the Detailed Description. For example, one embodiment comprises receiving a first address having a first n-bit portion and corresponding to a first pixel, receiving a second address having a second n-bit portion and corresponding to the first pixel, reversing the order of the second n-bit portion to form a reversed n-bit portion, and generating a first cache entry number derived from the first n-bit portion and the reversed n-bit portion.

This Summary is provided to introduce concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an embodiment apparatus to provide cache addresses to organize a data cache.

FIG. 2 shows an array of pixels including multiple rectangular shapes that have a locality of reference in a cache.

FIG. 3 shows a process flow depicting an embodiment cache arrangement method for a graphical application.

### DETAILED DESCRIPTION

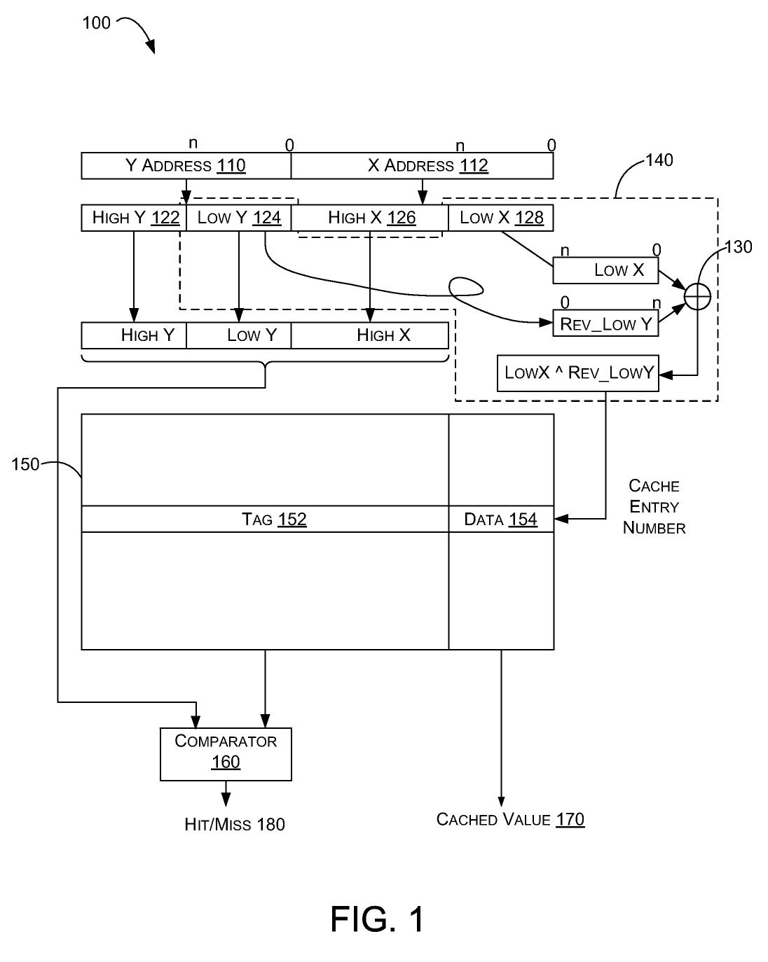

FIG. 1 shows an embodiment system 100 to generate cache entry numbers for data cache 150. System 100 will be described in reference to data cache 150, but the present approach is also applicable to caches that may store multi-dimensional addresses, including a CPU cache, and a graphics processor cache, an image processing system such as a vision system, etc. Additionally, in the present example a cache entry number is used to refer to a cache entry location, but in other cases a cache entry number may also be referred to as a cache address, a cache index, etc.

Embodiments described herein relate to graphical applications with pixel or texel graphics arrays, but other embodiments are not so limited. In some embodiments using graphics processors (GPUs) or other image analysis, the image data may exhibit a locality of reference where a number of pixels in a small region may be accessed near the same time while the precise nature of their locality is difficult to predict. For example, a tall narrow region of pixels may be accessed in one instance and a wide yet short region of pixels might be accessed in another instance.

In yet another embodiment, the approaches described herein may be applied to a CPU cache, wherein it could enhance the performance of the CPU when using graphics applications without necessarily having an adverse effect on the performance of the cache for non-graphical applications. Additionally, the techniques described herein may be applied to a direct mapped cache, a set associative cache, combinations of caches, or other suitable caching architectures.

Referring to the example illustrated in FIG. 1, system 100 generates cache entry numbers using the portions of X and Y addresses of a pixel array that are more likely to change in subsequent operations. In this way, system 100 can rearrange at least a portion of one of the addresses and perform a bitwise operation with a portion of the other address to distribute the portions of each address more likely to change over an increased number of cache entries, in turn reducing accesses to main memory based on cache entry reuse.

System 100 illustrates an approach that performs an exclusive OR operation between a portion of a first address and a reversed portion of a second address to generate a cache entry number, but other embodiments are not so limited. For example, other bitwise operations may be used, such as an XNOR, or other suitable bitwise operation, to combine multiple addresses to generate cache entry numbers that reduce cache entry reuse according to the principles of this disclosure. In alternate embodiments, a mathematical operation may be used. For example, an ADD operation such as by a full-adder, a ripple adder, etc., may add the binary numbers to create cache entry numbers. Other mathematical operations may be used according to the principles in this disclosure.

Additionally, system 100 is directed at a 2-dimensional example, but other embodiments are not so limited. Further, system 100 illustrates an approach that reverses a portion of one address, but other embodiments are not so limited. For example, an approach may reorder a portion of one address so that when two addresses are combined, the portion of one address that would more frequently change is not combined with the portion of the other address that would more frequently change. Therefore, cache entry numbers may be generated in a manner to reduce cache entry reuse by distributing cache entries that are more expected to change over an increased range of cache entries.

In a detailed example, system 100 includes a Y address 110 including more significant bits referred to as High Y 122 and less significant bits referred to as Low Y 124, and the X address 112 including more significant bits referred to as High X 126 and less significant bits referred to as Low X 128, as illustrated in FIG. 1.

In system 100, Low Y 124 and Low X 128 are each depicted as being the bottom n-bits of a corresponding Y address 110 and X address 112; however, other embodiments are not so limited. For example, for a cache entry number having a known bit depth, the bits for Low Y 124 and Low X 128 may have different bit depths and yet still be combinable to form a specific cache entry number according to the principles of this disclosure.

Dashed line 140 illustrates an example bitwise combination of portions of the Y address 110 and the X address 112. In particular, Low Y 124 may comprise the bottom n bits of y address 110 and may have their order reversed. Then, Low X 128 comprising the less significant bits of the X address 112 are combined with the reversed Low Y 124 in combiner 130.

For example, an embodiment apparatus may comprise a first register to receive a first address having a first n-bit portion as depicted by Y address 110 and a second register to receive a second address having a second n-bit portion as depicted by X address 112. The apparatus may further comprise an instruction sequence to reverse the order of the second n-bit portion to form a reversed n-bit portion, to generate a cache entry number derived from an exclusive OR operation between the first n-bit portion and the reversed n-bit portion, and to use the cache entry number to store data in a cache.

In system 100, the combiner 130 performs an exclusive OR operation between the bits of reversed Low Y 124 and Low X 128 to generate a cache entry number; but other embodiments are not so limited. For example, combiner 130 may perform a bitwise operation other than an exclusive OR to combine portions of the X and Y addresses to create a cache entry number, or may perform multiple bitwise operations to create a cache entry number, etc. In some embodiments, a mathematical operation may be used in place of the bitwise operation to generate a cache entry number according to the principles in this disclosure. The resulting cache entry number than may be used to access data cache 150.

In a read operation, a comparator 160 may compare a tag 152 corresponding to the generated cache entry number with a number containing the High Y 122, Low Y 124, and High X 126, to determine a cache hit or cache miss 180 and provide a cache value 170 corresponding to data 154 in response to a cache hit. However, the cache arrangement techniques described herein are not so limited and may be used in a read operation or within a write operation.

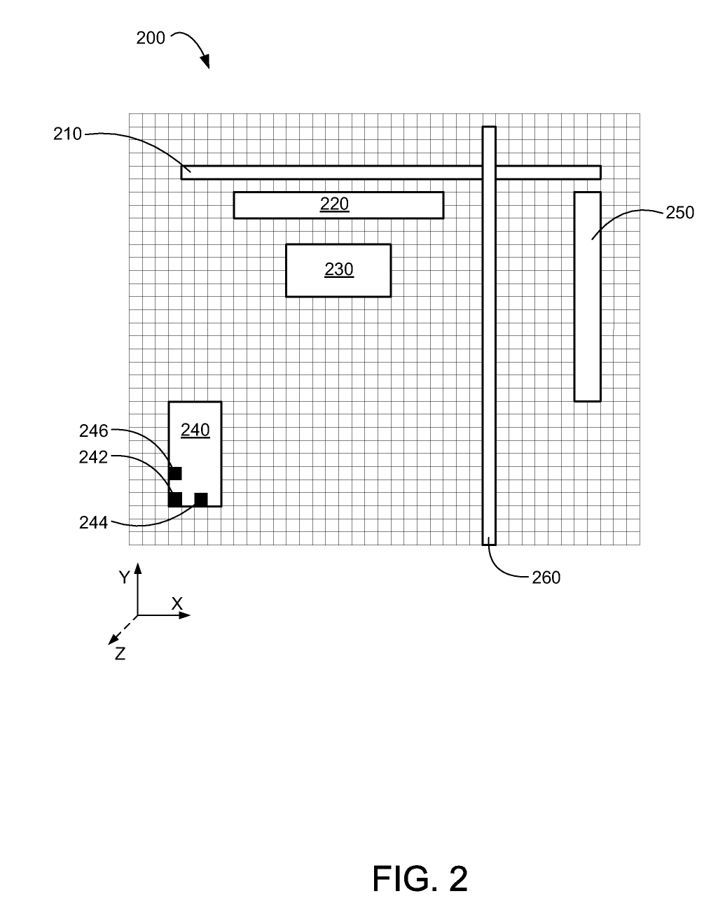

FIG. 2 shows an array 200 of pixels including multiple representative rectangular portions of the array that may advantageously be used in a cache arrangement according to the techniques described herein. The examples described with reference to array 200 include rectangular areas, but areas having other shapes may also exhibit locality of reference characteristics similar to rectangles and therefore benefit from cache arrangements and cache entry number techniques according to the principles described herein.

In some embodiments, a cache arrangement technique may provide cache entry numbers for any 2̂m by 2̂(n-m) rectangle within an array, wherein m may range from 0 to n. For example, array 200 is depicted with multiple rectangular areas including a 32 pixel wide by 1 pixel high rectangle 210, a 16 pixel wide by 2 pixel high rectangle 220, an 8 pixel wide by 4 pixel tall rectangle 230, a 4 pixel wide by 8 pixel tall rectangle 240, a 2 pixel wide by 16 pixel tall rectangle 250, and a 1 pixel wide by 32 pixel high rectangle 260.

Array 200 includes a horizontal X axis and a vertical Y axis, as arranged in FIG. 2. The present example rectangles each include 32 pixels, wherein each pixel has an X address and a Y address within the array. Therefore, in the present example each of these rectangles may be represented in a cache having 5-bit cache entry numbers, but other embodiments are not so limited. Some embodiments may include other data arrangements, for example a 3-dimensional array may also include a Z axis that is orthogonal to both the X axis and the Y axis.

In a 2-dimensional example with a 5-bit cache entry number, the lower left corner of array 200 may be an origin for all X and Y addresses in array 200. Further, array 200 includes pixel 242, pixel 244 and pixel 246, all three within rectangle 240. Considering the lower left corner of array 200 as the origin, pixel 242 will have an X address and a Y address of the decimal value 4, or as represented in binary each as the address 00100 as a 5-bit cache entry number.

Furthermore, pixel 244 has an X address of 00110 and a Y address of 00100, and pixel 246 has an X address of 00100 and a Y address of 00110. Therefore, if the X address and Y address are directly combined with a bitwise exclusive OR operation to generate a cache entry number for each pixel, then the cache entry number for pixel 242 would be 00000, the cache entry number for pixel 244 would be 00010 and the cache entry number for pixel 246 would be 00010. In this case, the cache entry number for pixel 244 and for pixel 246 would be the same, thus resulting in a reuse of that cache line and at least one memory access to main memory.

Continuing with the current example, if the n-bit portion used as the 5-bit cache entry number is the X address and the Y address listed above, then if the Y address is reversed for pixel 244 it would be 00100 while the reversed Y address for pixel 246 would be 01100. Due to this change, the exclusive OR operation would result in different values for pixel 244 and pixel 246, that is, pixel 244 would have a cache entry number of 00010, pixel 246 would have a cache entry number of 01000, and pixel 242 would still have a cache entry number of 00000. In this way, all three pixels would have different cache entry numbers according to the approach described with reference to FIG. 1.

Additionally, representative areas need not be placed at particular locations in an array to benefit from the techniques herein due to the looping principle of binary numbers. For example, for any range of binary numbers, each binary representation within a specific bit-width is different. In this way, a range of cache entry numbers may be generated independent of adjacent X addresses or Y addresses of a pixels in the array so long as the range of pixels fits within the number of cache entries. In limited cases where a cache entry may be reused, the approaches described herein still improve cache performance by reducing cache entry reuse in a portion of memory accesses.

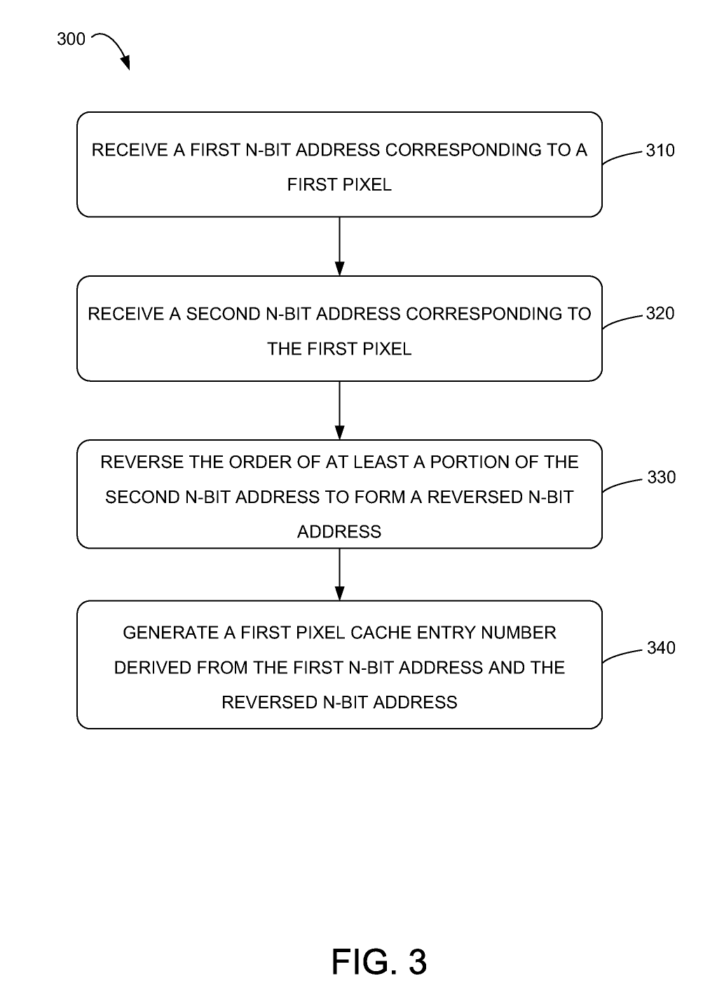

FIG. 3 shows a process flow depicting an embodiment cache arrangement method 300 for a graphical application. First, as indicated in block 310, method 300 comprises receiving a first address having a first n-bit portion and corresponding to a first pixel. Method 300 is described with reference to a pixel within an array of pixels, but other embodiments are not so limited. For example, other graphical elements such as texels may be used instead of pixels, or other arrays of data that exhibit locality of reference characteristics similar to graphics arrays may include other data elements that may be used in place of pixels in method 300.

Method 300 also comprises receiving a second address having a second n-bit portion and corresponding to the first pixel, as indicated in block 320. Similarly, an embodiment may receive the n-bit portion without the full first address or full second address. Additionally, the first n-bit portion and the second n-bit portion may be different sizes. For example, in one embodiment the first n-bit portion may be n-m bits wide and the second n-bit portion may be m bits wide. Other embodiments may combine a portion of two addresses to generate cache entry numbers to increase cache efficiency according to the principles herein.

Next, method 300 comprises reversing the order of the second n-bit portion to form a reversed n-bit portion, as indicated at block 330. Additionally, some embodiments may reverse the order of the first n-bit portion. For example, if the first n-bit portion corresponds to X address and the second n-bit portion corresponds to a Y address, an cache arrangement approach would benefit from the principles herein irrespective of if the X address portion or the Y address portion was re-ordered.

Some embodiments may reorder the one n-bit portion in a manner other than reversing them. For example, the second n-bits may be ordered inside-out, where the low order bits are placed in the middle of the second n-bit portion. This approach may be useful for arrays with higher dimensions than two. For example, in a 3 dimensional graphics application with an X, Y, and Z address for each picture or texture element, a cache arrangement may benefit by distributing the more likely to change bits from each of the X, Y, and Z addresses to different portions of a cache entry number.

Method 300 then comprises and generating a first pixel cache entry number derived from the first n-bit portion and the reversed n-bit portion, as shown in block 340. For example, the first n-bit portion may be the low order n-bit portion of a first address, such as an X address of a pixel in an array of pixels, and the second n-bit portion may be the low order n-bit portion of a second address, such as a Y address of the same pixel.

In some embodiments, generating a first pixel cache entry number includes performing a bitwise or a mathematical operation between the low order n-bit portion of the first address and the reversed low order n-bit portion of the second address. In one specific example, generating a first pixel cache entry number includes performing an exclusive OR operation between a low order n-bit portion of the first address and a reversed low order n-bit portion of the second address, but other embodiments are not so limited. For example, other mathematical operations may be used to combine multiple addresses to generate cache entry numbers that reduce cache entry reuse according to the principles of this disclosure.

Additionally, some embodiments may generate multiple cache entry numbers according to multiple pixels, texels, or other arrays of data. For example, method 300 may further comprise generating a second pixel cache entry number for a second pixel derived from a low order n-bit portion of a third address and a reversed low order n-bit portion of a fourth address, wherein the second pixel cache entry number is a different number than the first pixel cache entry number.

Some embodiments may use different groups of n-bits to generate a cache entry. For example in method 300, reversing the order of a second n-bit portion to form a reversed n-bit portion may further include reversing the order of the n+1 to the 2n bits of an address to form a reversed n-bit portion, but other embodiments are not so limited. Some embodiments may generate cache entry numbers from three unique addresses, such as from a 3-dimensional array. For example, the present method may further include generating an intermediate pixel cache entry number derived from the first n-bit portion and the reversed n-bit portion, and generating a first pixel cache entry number by performing an exclusive OR operation with an inside-out next n bits of an address. For example, the inside-out next n-bit portion may be a portion of a Z address, thus creating a cache arrangement approach for a 3-dimensional array.

In one example 3-dimensional array method, consider 10 bits for each portion of an address, that is, for each n. In this case, a first n-bit portion may be the bits {9, 8, 7, 6, 5, 4, 3, 2, 1, 0} of an address, and may be exclusive OR'd with the bits {10, 11, 12, 13, 14, 15, 16, 17, 18, 19} of an address. Then, the number resulting from this first exclusive OR operation may be exclusive OR'd with bits {29, 27, 25, 23, 21, 20, 22, 24, 26, 28} of an address. In this example the second group of bits is in reverse order and the third group of bits is in an inside-out order, but other embodiments are not so limited. For example, n-bit portions or full addresses may be arranged differently and different operations may be performed between the bits to generate a range of cache entry numbers according to the principles of this disclosure.

While a hardware implementation may generate cache entry numbers relatively quickly, it will be appreciated that the embodiments described herein may be implemented, for example, via computer-executable instructions or code, such as programs, stored on a computer-readable medium comprising instructions executable by a computing device to enable cache arrangement for graphical applications. Generally, programs include routines, objects, components, data structures, and the like that perform particular tasks or implement particular abstract data types. As used herein, the term “program” may connote a single program or multiple programs acting in concert, and may be used to denote applications, services, or any other type or class of program. Likewise, the terms “computer” and “computing device” as used herein include any device that electronically executes one or more programs, including, but not limited to personal computers, surface computers, servers, laptop computers, hand-held devices, cellular phones, and other suitable microprocessor-based programmable consumer electronics and/or appliances.

It will further be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of any of the above-described processes is not necessarily required to achieve the features and/or results of the embodiments described herein, but is provided for ease of illustration and description. The subject matter of the present disclosure includes all novel and nonobvious combinations and subcombinations of the various processes, systems and configurations, and other features, functions, acts, and/or properties disclosed herein, as well as any and all equivalents thereof.

1. A cache arrangement method for a graphical application, the method comprising:
receiving a first address having a first n-bit portion and corresponding to a first pixel;
receiving a second address having a second n-bit portion and corresponding to the first pixel;
reversing the order of the second n-bit portion to form a reversed n-bit portion; and
generating a first cache entry number derived from the first n-bit portion and the reversed n-bit portion.

2. The cache arrangement method of claim 1, wherein the first n-bit portion is the low order n-bit portion of the first address and the second n-bit portion is the low order n-bit portion of the second address.

3. The method of claim 1, wherein generating a first cache entry number includes performing an exclusive OR operation between a low order n-bit portion of the first address and a reversed low order n-bit portion of the second address.

4. The method of claim 1, wherein the first address is an X address in an array of pixels, and the second address is a Y address in the array of pixels.

5. The method of claim 1, further comprising:
generating a second cache entry number for a second pixel derived from a low order n-bit portion of a third address and a reversed low order n-bit portion of a fourth address, wherein the second cache entry number is a different number than the first cache entry number.

6. The method of claim 1, wherein generating a first cache entry number includes performing a bitwise operation between the low order n-bit portion of the first address and the reversed low order n-bit portion of the second address.

7. The method of claim 1, wherein the cache arrangement method is used for a set associative cache.

8. The method of claim 1, wherein reversing the order of the second n-bit portion to form a reversed n-bit portion includes reversing the order of the n+1 to the 2n bits of an address to form a reversed n-bit portion.

9. The method of claim 8, further comprising:
generating an intermediate cache entry number derived from the first n-bit portion and the reversed n-bit portion; and
generating a first cache entry number by performing an exclusive OR operation with an inside-out next n bits of an address.

10. A computer-readable medium comprising instructions executable by a computing device to enable cache arrangement for graphical applications, the instructions being executable to perform a method comprising:
receiving a first address having a first n-bit portion and corresponding to a first pixel;
receiving a second address having a second n-bit portion and corresponding to the first pixel;
reversing the order of the second n-bit portion to form a reversed n-bit portion; and
generating a first cache entry number derived from the first n-bit portion and the reversed n-bit portion.

11. The computer-readable medium of claim 10, wherein the first n-bit portion is the low order n-bit portion of the first address and the second n-bit portion is the low order n-bit portion of the second address.

12. The computer-readable medium of claim 10, wherein generating a first cache entry number includes performing an exclusive OR operation between a low order n-bit portion of the first address and a reversed low order n-bit portion of the second address.

13. The computer-readable medium of claim 10, wherein the first address is an X address in an array of pixels, and the second address is a Y address in the array of pixels.

14. The computer-readable medium of claim 10, further comprising instructions for generating a second cache entry number for a second pixel derived from a low order n-bit portion of a third address and a reversed low order n-bit portion of a fourth address, wherein the second cache entry number is a different number than the first cache entry number.

15. The computer-readable medium of claim 10, wherein generating a first cache entry number includes performing a bitwise operation between the low order n-bit portion of the first address and the reversed low order n-bit portion of the second address.

16. The computer-readable medium of claim 10, wherein the cache arrangement method is used for a set associative cache.

17. The computer-readable medium of claim 10, wherein reversing the order of the second n-bit portion to form a reversed n-bit portion includes reversing the order of the n+1 to the 2n bits of an address to form a reversed n-bit portion.

18. The computer-readable medium of claim 17, further comprising instructions for:
generating an intermediate cache entry number derived from the first n-bit portion and the reversed n-bit portion; and
generating a first cache entry number by performing an exclusive OR operation with an inside-out next n bits of an address.

19. The computer-readable medium of claim 18, wherein the inside-out next n-bit portion is a portion of a Z address.

20. An apparatus comprising:
a first register to receive a first address having a first n-bit portion;
a second register to receive a second address having a second n-bit portion; and
a combiner to:
reverse the order of the second n-bit portion to form a reversed n-bit portion;
generate a cache entry number derived from an exclusive OR operation between the first n-bit portion and the reversed n-bit portion; and
use the cache entry number to store data in a cache.
